(19) United States
(12) Patent Application Publication
(10) Pub. No.: US 2026/0039521 A1
(43) Pub. Date: Feb. 5, 2026

(54) TRANSMISSION DEVICE, TRANSMISSION METHOD, RECEPTION DEVICE, AND RECEPTION METHOD

(71) Applicant: KYOTO UNIVERSITY, Kyoto-shi (JP)

(72) Inventors: Keiichi MIZUTANI, Kyoto-shi (JP); Hiroshi HARADA, Kyoto-shi (JP); Yuu ICHIKAWA, Kyoto-shi (JP)

(73) Assignee: KYOTO UNIVERSITY, Kyoto-shi (JP)

(21) Appl. No.: 19/100,386

(22) PCT Filed: Jul. 27, 2023
(86) PCT No.: PCT/JP2023/027477

§ 371 Date: Jan. 31, 2025

(30) Foreign Application Priority Data
Aug. 10, 2022 (JP) 2022-127879

(51) Int. Cl. H04L 27/26

(52) U.S. Cl. CPC H04L 27/26

(57) ABSTRACT

Provided is a transmission device that is compatible with conventional schemes and can improve transmission efficiency. A transmission device of an orthogonal frequency division multiplexing scheme, includes: a redundant signal addition circuit that adds a redundant signal of a predetermined number of sampling points to multiple sampling points of an output of an IFFT circuit or an IDFT circuit; and a sampling point truncation circuit that truncates a predetermined number of sampling points from each of a front end and a rear end of an output of the redundant signal addition circuit. An output symbol of the sampling point truncation circuit is transmitted.

### TECHNICAL FIELD

The present invention relates to a transmission device, a transmission method, a reception device, and a reception method that can be used in a next-generation mobile communication system.

### TECHNICAL BACKGROUND

The OFDM (Orthogonal Frequency Division Multiplexing) scheme, as a current mainstream communication scheme, is adopted in various systems such as wireless LAN (Local Area Network), 4G (4th Generation: 4th generation mobile communication system), 5G (5th Generation: 5th Generation mobile communication system), and terrestrial digital broadcasting. The OFDM scheme is a multi-carrier scheme in which multiple subcarriers are simultaneously transmitted. In the OFDM scheme, complex information symbols of multiple subcarriers arranged in the frequency domain are subjected to IFFT (Inverse Fast Fourier Transform) or IDFT (Inverse Discrete Fourier Transform) to generate a time-domain waveform of a transmission signal thereof.

The CP-OFDM scheme is known as one of the technologies based on the OFDM scheme. In the CP-OFDM scheme, multiple OFDM symbols each with a temporal redundancy interval called a guard interval (CP (Cyclic Prefix)) added to a time-domain waveform are concatenated and transmitted. In the CP-OFDM scheme, inter-carrier interference (ICI) can be suppressed by inserting data for a certain period of time from the rear end of an OFDM symbol as a CP at the beginning of the OFDM symbol.

On the receiving side, the concatenated OFDM symbols are processed one by one. The guard intervals are respectively removed from the OFDM symbols, and the remaining signal intervals are subjected to FFT (Fast Fourier Transform) or DFT (Discrete Fourier Transform) to restore the complex information symbols of the subcarrier signals in the frequency domain. By performing IFFT or IDFT on the transmitting side and FFT or DFT on the receiving side, the orthogonal relationship between the subcarriers is maintained, and thus, no inter-carrier interference occurs and multiple complex information symbols can be transmitted simultaneously without interference.

Currently, new communication schemes to be adopted for 6G (6th Generation: Sixth-Generation Mobile Communication Systems) and later communication systems are being developed worldwide. However, a communication scheme capable of achieving transmission efficiency equal to or higher than the OFDM scheme has yet to be invented, and as a result, the OFDM scheme has continued to be adopted since 4G. Further, considering compatibility, there is a demand for a new scheme that improves transmission efficiency while being based on the OFDM scheme.

A zero-padding (ZP-) OFDM scheme, as a scheme using symbol end truncation to increase the transmission rate, is described in Non-Patent Document 1. This scheme is a scheme in which zero data is inserted into the CP interval.

### RELATED ART

### Non-Patent Document

Non-Patent Document 1: F. Schaich, T. Wild, and Y. Chen, “Waveform contenders for 5G-Suitability for short packet and low latency transmissions,” IEEE VTC2014-Spring, pp. 1-5, May 2014.

### SUMMARY OF THE INVENTION

### Problems to be Solved by the Invention

In the ZP-OFDM scheme, there is a problem that truncated intervals remain as guard intervals (GI) and thus, transmission time cannot be shortened. In order to further improve the transmission efficiency of the OFDM scheme, the present invention is intended to improve temporal efficiency and increase transmission speed by truncating a part of each OFDM symbol and concatenating multiple OFDM symbols without leaving guard intervals.

Therefore, an object of the present invention is to provide a transmission device, a transmission scheme, a reception device, and a reception method that can further improve the transmission efficiency of the OFDM scheme.

### Means for Solving the Problems

A transmission device of an orthogonal frequency division multiplexing scheme of the present invention includes:
a redundant signal addition circuit that adds a redundant signal of a predetermined number of sampling points to multiple sampling points of an output of an IFFT circuit or an IDFT circuit; and
a sampling point truncation circuit that truncates a predetermined number of sampling points from each of a front end and a rear end of an output of the redundant signal addition circuit, wherein
an output symbol of the sampling point truncation circuit is transmitted.

Further, a transmission method of an orthogonal frequency division multiplexing scheme of the present invention includes:
a redundant signal addition process for adding a redundant signal of a predetermined number of sampling points to multiple sampling points of an output of an IFFT circuit or an IDFT circuit;
a sampling point truncation process for truncating a predetermined number of sampling points from each of a front end and a rear end of a symbol to which a redundant signal has been added; and
transmitting a symbol from which sampling points have been truncated.

Further, a reception device of an orthogonal frequency division multiplexing scheme of the present invention includes:
a zero insertion circuit for inserting zero sampling points, equal in number to those truncated on a transmitting side, into a received symbol;
a redundant signal removal circuit for removing a redundant signal from an output of the zero insertion circuit; and
a Fourier transform circuit for performing Fourier transform on an output of the redundant signal removal circuit.

Further, a reception method of an orthogonal frequency division multiplexing scheme of the present invention includes:
a zero insertion process for inserting zero sampling points, equal in number to those truncated on a transmitting side, into a received symbol;
a redundant signal removal process for removing a redundant signal from a symbol into which zero sampling points have been inserted; and
performing FFT or DFT, with an FFT circuit or a DFT circuit, on an output from which a redundant signal has been removed.

### Effect of Invention

The present invention is compatible with conventional OFDM schemes and can improve throughput. The effects described herein are not necessarily limited, and may be any effect described in the present invention. Further, the content of the present invention is not to be interpreted in a limited manner by the effects exemplified in the following description.

### BRIEF DESCRIPTION OF DRAWING

FIG. 1 is a block diagram illustrating a structure of a transmitter of the CP-OFDM scheme.

FIG. 2 is a block diagram illustrating a structure of a receiver of the CP-OFDM scheme.

FIG. 3 is a block diagram illustrating a structure of a transmitter of an embodiment of the present invention.

FIGS. 4A and 4B are respectively schematic diagrams for describing a symbol structure of the CP-OFDM scheme and a symbol structure of the embodiment of the present invention.

FIGS. 5A, 5B and 5C are respectively timing charts used in describing the CP-OFDM scheme, the ZP-OFDM scheme and the embodiment of the present invention.

FIG. 6 is a block diagram illustrating a structure of a receiver of the embodiment of the present invention.

FIG. 7 is a graph for evaluating bit error rates.

FIG. 8 is a graph for evaluating bit error rates.

FIG. 9 is a graph for evaluating bit error rates.

FIG. 10 is a graph showing the maximum throughput achievable by the present invention for each MCS.

FIG. 11 is a graph for evaluating throughput characteristics when optimal MCS and N_{SP} can be adaptively selected.

FIG. 12 is a graph for evaluating throughput characteristics when optimal MCS and N_{SP} can be adaptively selected.

FIG. 13 is a graph for evaluating throughput characteristics when optimal MCS and N_{SP} can be adaptively selected.

### MODE FOR CARRYING OUT THE INVENTION

In the following, an embodiment of the present invention is described. The embodiment to be described below is a preferred specific example of the present invention, and various technically preferable limitations are attached. However, the scope of the present invention is not limited to these embodiments unless otherwise specifically stated in the following description as limiting the present invention.

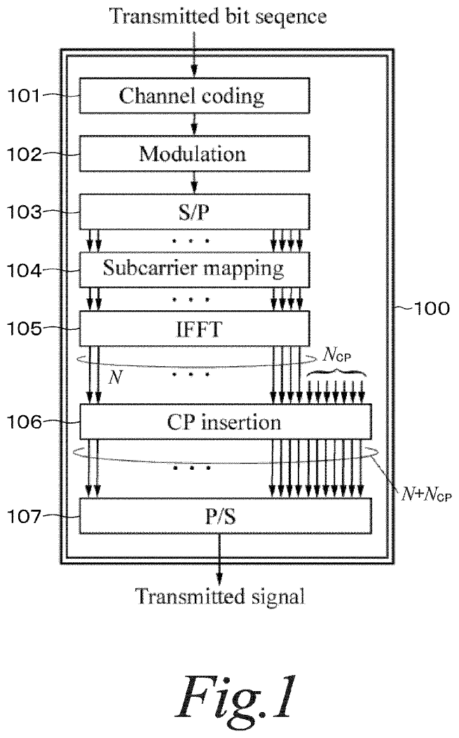

First, the conventional CP-OFDM scheme, which is adopted in many wireless communication systems, including the current 5G, is described. FIG. 1 illustrates a structure of a transmitter 100 of the CP-OFDM scheme. A transmission signal is supplied to a channel coding circuit 101, where channel coding processing is performed. An output sequence of the channel coding circuit 101 is modulated by a modulation circuit 102, resulting in complex symbols. Next, the obtained complex symbols are parallelized by a serial-to-parallel conversion circuit 103.

An output signal of the serial-to-parallel conversion circuit 103 is mapped to a frequency domain along with a reference signal by a subcarrier mapping circuit 104. An output of the subcarrier mapping circuit 104 is subjected to IFFT or IDFT by an IFFT circuit 105. N sampling points output from the IFFT circuit 105 are supplied to a CP insertion circuit 106, where a CP (Cyclic Prefix) as a redundant signal is inserted, generating a CP-OFDM symbol at an output of the CP insertion circuit 106. The number of CP sampling points is denoted as N_{CP}. CP-OFDM symbols are serialized by a parallel-to-serial conversion circuit 107 and transmitted to a transmission channel. For example, data for a certain period of time from the rear end of an OFDM symbol is inserted at the beginning of the OFDM symbol as a cyclic prefix.

The m-th CP-OFDM symbol shown in Mathematical Formula 1 is expressed as Mathematical Formula 2 (Equation (1)). N is the number of subcarriers.

$$[ Mathematical Formula 1 ]$$

$${s}_{m} = ∈ {ℂ}^{N \times 1}$$

$$[ Mathematical Formula 2 ]$$

$${s}_{m} = {CF}^{- 1} {x}_{m} \qquad ( 1 )$$

In Mathematical Formula 2 (Equation (1)), xₘ represents modulated subcarrier symbols expressed in the frequency domain, and is represented by Mathematical Formula 3, and the inverse discrete Fourier transform matrix is represented by Mathematical Formula 4.

$$[ Mathematical Formula 3 ]$$

$${x}_{m} = {[ {x}_{( m , 0 )} , … , {x}_{( m , N - 1 )} ]}^{T} ∈ {ℂ}^{N \times 1}$$

$$[ Mathematical Formula 4 ]$$

$${F}^{- 1} ∈ {ℂ}^{N \times N}$$

Elements of the IDFT matrix are represented by Mathematical Formula 5.

$$[ Mathematical Formula 5 ]$$

$${F}^{- 1} ( p , q ) = \frac{1}{\sqrt{N}} exp ( \frac{j 2 π pq}{N} )$$

$$0 \leq p < N$$

$$0 \leq q < N$$

Further, the CP insertion matrix is represented by Mathematical Formulas 6 and 7. N_{CP} is the number of time samples corresponding to the CP. The term of Mathematical Formula 8 in Mathematical Formula 7 is an i-row by j-column matrix with all elements equal to 0, and IN represents an N-row by N-column unit matrix.

$$[ Mathematical Formula 6 ]$$

$$C = {[ {G}^{T} , {I}_{N}^{T} ]}^{T} ∈ {ℤ}^{〈 N + {N}_{C P} ) \times N}$$

$$[ Mathematical Formula 7 ]$$

$$G = [ {0}^{{N}_{CP} \times ( N - {N}_{CP} )} , {I}_{{N}_{CP}} ]$$

$$[ Mathematical Formula 8 ]$$

$${0}^{i \times j}$$

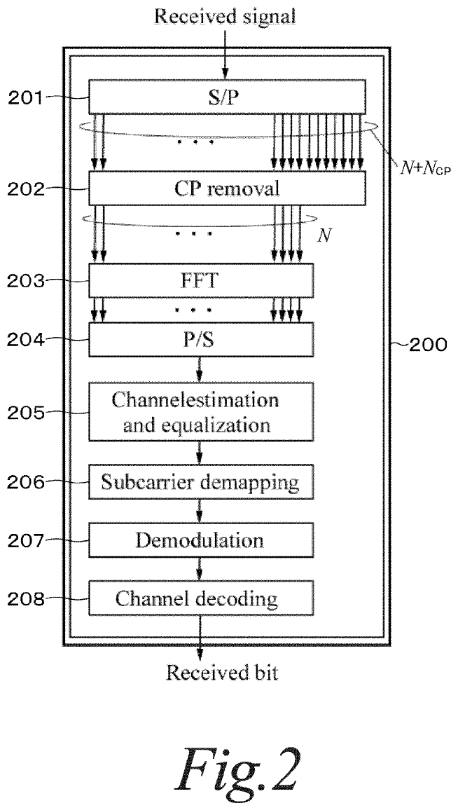

FIG. 2 illustrates a structure of a receiver 200 of the CP-OFDM scheme. A reception signal is supplied to a serial-to-parallel conversion circuit 201, where it is converted into a parallel signal. An output of the serial-to-parallel conversion circuit 201 (with a sample count of N+N_{CP}) is supplied to a CP removal circuit 202, where the CP is removed. A reception signal with the CP removed is supplied to an FFT circuit 203, where FFT or DFT is performed, resulting in a complex symbol mapped to the frequency domain. The reception symbol sequence is represented by Mathematical Formula 9 (Equation (2)).

$$[ Mathematical Formula 9 ]$$

$${y}_{m} = FD ( C {F}^{- 1} {x}_{m} + {n}_{m} ) \qquad ( 2 )$$

Here, nₘ is zero-mean complex Gaussian noise. The CP removal matrix in Mathematical Formula 9 is represented by Mathematical Formula 10.

$$[ Mathematical Formula 10 ]$$

$$D = {[ {I}_{N} , {0}^{N \times {N}_{CP}} ]}^{T} ∈ {ℤ}^{N \times ( N + {N}_{CP} )}$$

The DFT matrix is represented by Mathematical Formula 11, and its elements are represented by Mathematical Formula 12.

$$[ Mathematical Formula 11 ]$$

$$F ∈ {ℂ}^{N \times N}$$

$$[ Mathematical Formula 12 ]$$

$$F ( p , q ) = \frac{1}{\sqrt{N}} exp ( \frac{- j 2 π pq}{N} )$$

An output signal of the FFT circuit 203 is supplied to a parallel-to-serial conversion circuit 204, where it is serialized. An output signal of the parallel-to-serial conversion circuit 204 is supplied to a channel estimation and channel equalization circuit 205. An output signal of the channel estimation and channel equalization circuit 205 is supplied to a subcarrier demapping circuit 206, and an output of the subcarrier demapping circuit 206 is supplied to a demodulation circuit 207. An output of the demodulation circuit 207 is supplied to a channel decoding circuit 208, where, for example, LDPC code decoding is performed, and a reception sequence is obtained.

Next, the embodiment of the present invention is described. A scheme of the present invention is referred to as an STT (Symbol-edges Truncating Transmission)-OFDM scheme. On the transmitting side, by transmitting only a part of a CP-OFDM symbol, time efficiency of the conventional OFDM can be improved. On the receiver side, zeros are interpolated into portions that are not transmitted, and then normal OFDM demodulation processing is performed. When using the STT-OFDM scheme, inter-carrier interference occurs. However, by using powerful error correction codes such as LDPC codes, communication quality can be maintained even when some symbols are lost. Therefore, in the STT-OFDM scheme, a reduction in transmission energy per symbol compared to the CP-OFDM scheme can be expected.

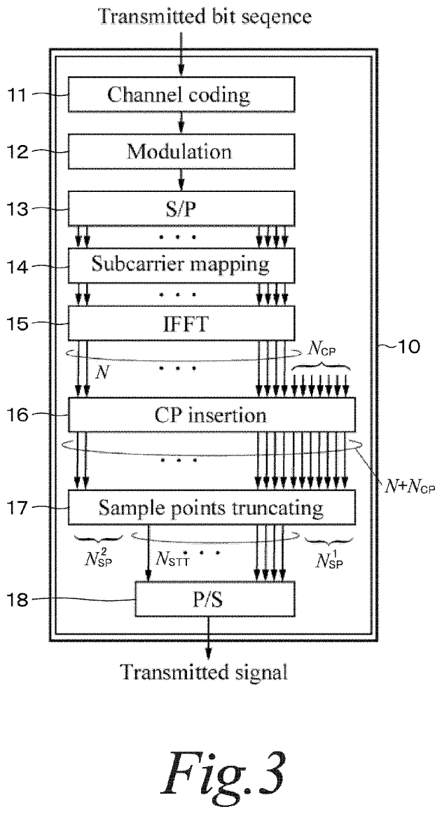

FIG. 3 illustrates a structure of a transmitter 10 of the embodiment of the present invention. Similar to the above-described CP-OFDM scheme, a CP-OFDM symbol is generated. That is, a transmission signal is supplied to a channel coding circuit 11, and an output sequence of the channel coding circuit 11 is modulated by a modulation circuit 12, resulting in complex symbols. Next, the complex symbols are parallelized by a serial-to-parallel conversion circuit 13. An output signal of the serial-to-parallel conversion circuit 13 is mapped to a frequency domain along with a reference signal by a subcarrier mapping circuit 14.

An output of the subcarrier mapping circuit 14 is subjected to IFFT or IDFT by an IFFT circuit 15. An output of the IFFT circuit 15 is supplied to a CP insertion circuit 16, where a CP is inserted, generating a CP-OFDM symbol with a sample point count of N+N_{CP} at an output of the CP insertion circuit 16. This CP-OFDM symbol is represented by Mathematical Formula 2 (Equation (1)) described above.

The CP-OFDM symbol output from the CP insertion circuit 16 is supplied to a sampling point truncation circuit 17. The sampling point truncation circuit 17 truncates an arbitrary number of symbol points (time sampling points) at the beginning and end of a CP-OFDM symbol. STT-OFDM symbols output from the sampling point truncation circuit 17 are concatenated into serial data in a parallel-to-serial conversion circuit 18 and transmitted to a transmission channel.

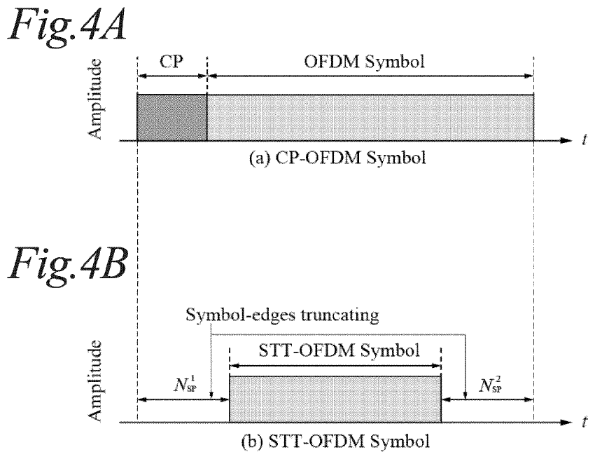

FIG. 4A illustrates a CP-OFDM symbol obtained as an output of the CP insertion circuit 16. The CP-OFDM symbol is obtained by adding a CP before an OFDM symbol. As illustrated in FIG. 4B, the sampling point truncation circuit 17 forms an STT-OFDM symbol by truncating an arbitrary number of sampling points from the beginning and end of a CP-OFDM symbol.

The m-th STT-OFDM symbol, shown in Mathematical Formula 13, is expressed by Mathematical Formula 14 (Equation (3)). Further, in Mathematical Formula 14 (Equation (3)), s(m, n) denotes the n-th sampling point of the m-th STT-OFDM symbol.

$$[ Mathematical Formula 13 ]$$

$${p}_{m} ∈ {ℂ}^{{N}_{STT} \times 1}$$

$$[ Mathematical Formula 14 ]$$

$${p}_{m} = {[ {S}_{( m , {N}_{SP}^{1} )} , {S}_{( m , {N}_{SP}^{1} + 1 )} , … , {S}_{( m , N − {N}_{SP}^{2} − 1 )} ]}^{T} \qquad ( 3 )$$

The sampling points truncated by the sampling point truncation circuit 17 are represented by Mathematical Formula 15, and the number of truncated sampling points is represented by Mathematical Formula 16. As shown by Mathematical Formula 15, the number of truncated sampling points is arbitrary, and may be shorter or longer than the CP (guard interval). Further, it is not necessary for the number of truncated sampling points to be equal in front and rear intervals.

$$[ Mathematical Formula 15 ]$$

$${N}_{SP}^{l} ( l = 1 , 2 )$$

$$[ Mathematical Formula 16 ]$$

$$0 \leq {\sum }_{l} {N}_{SP}^{l} < N$$

The number of sampling points of an STT-OFDM symbol is expressed by Mathematical Formula 17.

$$[ Mathematical Formula 17 ]$$

$${N}_{S T T} = N + {N}_{CP} - {\sum }_{l} {N}_{SP}^{l}$$

The case of Mathematical Formula 18 shows the same signal waveform as the CP-OFDM symbol.

$$[ Mathematical Formula 18 ]$$

$${N}_{SP}^{1} = {N}_{SP}^{2} = 0$$

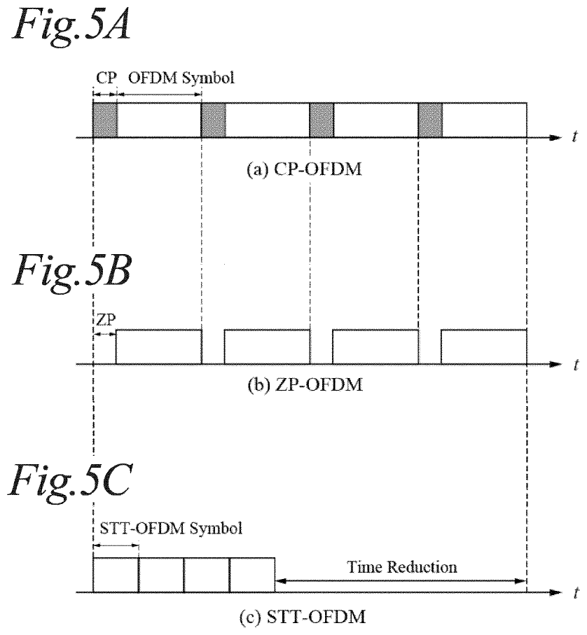

FIG. 5A illustrates a transmission signal in which four symbols are concatenated, using CP-OFDM symbols as an example. FIG. 5B illustrates a transmission signal in which four symbols are concatenated, using the zero-padding (ZP-) OFDM scheme, which is known as one of schemes that use truncation of symbol edges, as an example. In the embodiment of the present invention (the STT-OFDM scheme), as illustrated in FIG. 5C, a predetermined number (four in the example illustrated) of generated STT-OFDM symbols are concatenated without gaps. In the ZP-OFDM scheme, truncated intervals are retained as guard intervals (GIs), whereas in the STT-OFDM scheme, STT-OFDM symbols are concatenated without retaining truncated intervals as guard intervals (GIs). The embodiment of the present invention can shorten transmission time compared to the CP-OFDM scheme and the ZP-OFDM scheme. In the present invention, it is also possible that the guard interval is not completely deleted, and an interval of a length within a range that can improve throughput is retained.

On the receiving side, zeros are inserted into missing portions, and transmission information is extracted in the same way as in the CP-OFDM scheme. Since only a portion is transmitted, the orthogonality between subcarriers is lost on the receiving side, resulting in inter-carrier interference. However, this effect can be mitigated by using error correction coding techniques, such as turbo codes or LDPC (Low-Density Parity-Check) codes.

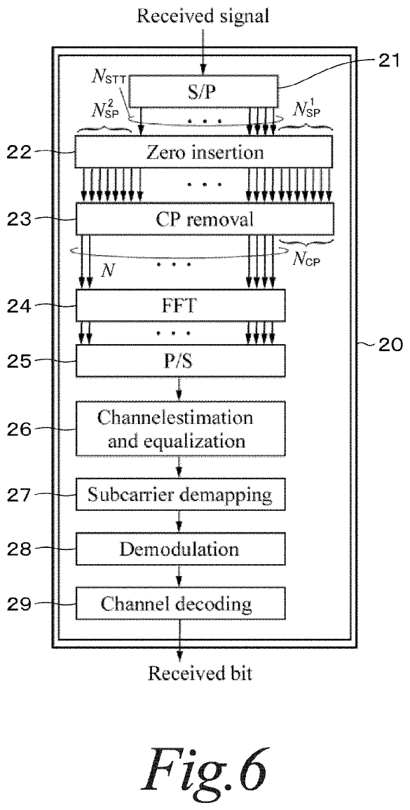

FIG. 6 illustrates an example of a structure of a receiver 20 in the embodiment of the present invention. This figure illustrates a receiver structure for sequentially extracting STT-OFDM symbols one by one from the beginning of a reception signal in which multiple STT-OFDM symbols are concatenated, and demodulating each extracted STT-OFDM symbol. Each STT-OFDM symbol extracted from the reception signal is supplied to a serial-to-parallel conversion circuit 21, where it is converted into a parallel signal with N_{STT} sampling points. An output of the serial-to-parallel conversion circuit 21 is supplied to a zero insertion circuit 22, where zeros are inserted into front and rear intervals that were truncated on the transmitting side. The zero insertion circuit 22 inserts zeros such that the number of sampling points in one OFDM symbol is N+N_{CP}. An output of the zero insertion circuit 22 is supplied to a CP removal circuit 23, where the CP (guard interval) is removed. A reception signal with the CP removed is supplied to an FFT circuit 24, where FFT or DFT is performed, resulting in a complex symbol mapped to the frequency domain.

An output signal of the FFT circuit 24 is supplied to a parallel-to-serial conversion circuit 25, where it is serialized. An output signal of the parallel-to-serial conversion circuit 25 is supplied to a channel estimation and channel equalization circuit 26. An output signal of the channel estimation and channel equalization circuit 26 is supplied to a subcarrier demapping circuit 27, and an output of the subcarrier demapping circuit 27 is supplied to a demodulation circuit 28. An output of the demodulation circuit 28 is supplied to a channel decoding circuit 29, where, for example, LDPC code decoding is performed, and a reception sequence is obtained.

In an AWGN (Additive White Gaussian Noise) environment, a reception signal is represented by Mathematical Formula 19 (Equation (4)).

$$[ Mathematical Formula 19 ]$$

$${p}_{m}^{′} = {p}_{m} + {n}_{m}^{′} \qquad ( 4 )$$

In Mathematical Formula 19 (Equation (4)), Mathematical Formula 20 represents zero-mean complex Gaussian noise.

$$[ Mathematical Formula 20 ]$$

$${n}_{m}^{′} ∈ {ℂ}^{{N}_{STT} \times 1}$$

The number of sampling points truncated on the transmitting side is represented by Mathematical Formula 21.

$$[ Mathematical Formula 21 ]$$

$${N}_{S P}^{l}$$

The zero insertion circuit 22 performs zero interpolation in which zeros equal in number to sampling points truncated on the transmitting side are added to the ends of an STT-OFDM symbol in a reception signal. As a result, a reception signal represented by Mathematical Formula 22 is obtained. This reception signal is represented by Mathematical Formula 23 (Equation (5)).

$$[ Mathematical Formula 22 ]$$

$${r}_{m} ∈ {ℂ}^{( N + {N}_{C P} ) \times 1}$$

$$[ Mathematical Formula 23 ]$$

$${r}_{m} = {[ {0}^{l \times {N}_{SP}^{1}} , {( {p}_{m}^{′} )}^{T} , {0}^{l \times {N}_{SP}^{2}} ]}^{T} \qquad ( 5 )$$

A reception signal that has been subjected to zero interpolation is subjected to reception signal processing similar to that in the CP-OFDM scheme, resulting in a reception symbol sequence represented by Mathematical Formula 24 (Equation (6)).

$$[ Mathematical Formula 24 ]$$

$${y}_{m}^{P} = {FDr}_{m} \qquad ( 6 )$$

Next, channel equalization and channel estimation are performed, and after demodulation, LDPC code decoding is performed to obtain a reception sequence. Here, a logarithmic domain sum-product decoding method is commonly used for LDPC code decoding.

This decoding method uses log likelihood ratio (LLR). Since an absolute value of LLR is inversely proportional to noise power, the absolute value of LLR takes a very large value in a high SNR environment. However, when a part of a transmission signal is truncated on the transmitting side, the orthogonality of OFDM is lost causing ICI. Therefore, in a high SNR environment, an LLR with a very large absolute value may be calculated for an incorrect code. Therefore, degradation of communication quality is suppressed by performing LLR adjustment at the output of the demodulation circuit 28.

Next, in order to evaluate performance of usefulness of the STT-OFDM scheme according to the present invention, a link level simulation of a 5G system in a case where the CP-OFDM scheme is replaced with the STT-OFDM scheme is performed. Parameter specifications of the link level simulation are shown in Table 1.

TABLE 1
Simulation parameter specifications

| Parameter | Value | |
|---|---|---|
| Carrier frequency | 4 | GHz |
| Subcarrier spacing | 15 | kHz |
| Channel bandwidth | 5 | MHz |

| | |
|---|---|
| Channel coding | NR LDPC |
| Modulation and Coding | MCS1-9, QPSK |
| Scheme (MCS) index | MCS10-16, 16QAM |
| [18], | MCS17-28, 64QAM |
| Modulation scheme | |
| Decoding algorithm | Log Sum-Product |
| Decoding iteration | 50 |
| IFFT size | 512 |
| CP rate | 36/512 |
| Channel model | AWGN |
| Antenna configuration | TX: 1, RX: 4(MRC) |

First, evaluation of the block error rate (BLER) of the STT-OFDM scheme when varying the truncated sampling points (represented by Mathematical Formula 21) in an AWGN environment was performed. Next, evaluation of the throughput that can be achieved when the STT-OFDM scheme is used was performed. As an example, as shown in Mathematical Formula 25, the number of sampling points truncated at the front and rear ends were set equal.

$$[ Mathematical Formula 25 ]$$

$${N}_{S P}^{1} = {N}_{SP}^{2} = {N}_{S P}$$

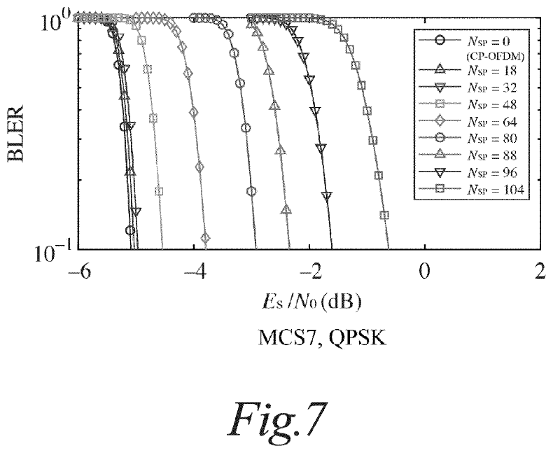

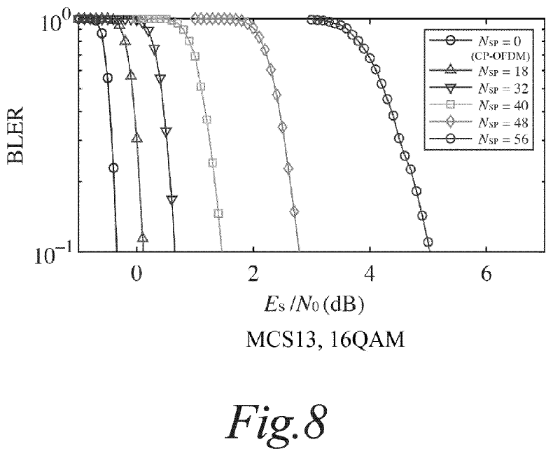

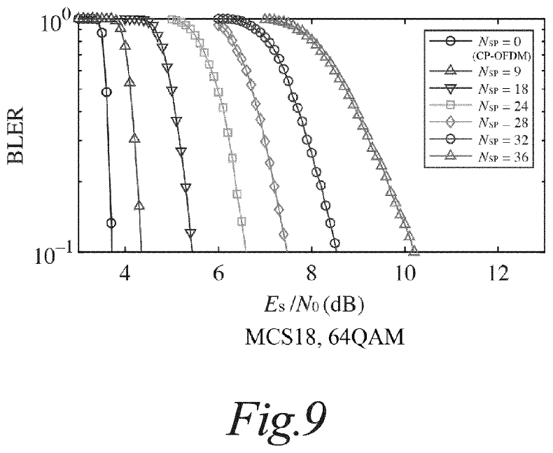

The results of the BLER characteristic evaluation are shown in FIGS. 7, 8 and 9. FIGS. 7, 8 and 9 show the BLER as a function of Es/No and represent BLER characteristics as a function of N_{SP}. N_{SP}=0 corresponds to the CP-OFDM scheme. A smaller value of Es/No indicates a higher level of noise. FIG. 7 shows the BLER characteristics for (MCS7 QPSK, 526/1024); FIG. 8 shows the BLER characteristics for MCS13 (16QAM, 490/1024); and FIG. 9 shows the BLER characteristics for MCS18 (64QAM, 466/1024).

MCS (Modulation and Coding Scheme) refers to a combination of a modulation scheme and a coding rate. As the MCS value increases, higher throughput is achieved. The MCS changes from low to high values, in the order of QPSK, 16QAM, and 64QAM. The modulation scheme for MCS1-MCS9 is QPSK, the modulation scheme for MCS10-MCS16 is 16QAM, and the modulation scheme for MCS17 and above is 64QAM.

In the case of MCS7 (QPSK) (FIG. 7), the degradation in Es/No to achieve the 3GPP (registered trademark) required BLER of 10⁻¹ is about 1 dB compared to the conventional CP-OFDM scheme in a range of N_{SP}<=64. Even when N_{SP}=104, that is, about half of the original CP-OFDM symbol is truncated, BLER=10⁻¹ can be achieved, although the required Es/No increases by about 4 dB. This shows that the effect of ICI that occurs in the STT-OFDM scheme can be suppressed by LDPC encoding.

In the case of MCS13 (16QAM) (FIG. 8), the degradation in Es/No to achieve BLER=10⁻¹ is about 1 dB in a range of N_{SP}<=32. The magnitude of N_{SP} becomes smaller than QPSK. This is because, unlike QPSK, 16QAM also has information in amplitude, and thus, even when the effect of ICI is suppressed by LDPC coding, the residual interference components have a large effect on 16QAM demodulation.

In the case of MCS18 (64QAM) (FIG. 9), the degradation of Es/No to achieve BLER=10⁻¹ in the STT-OFDM scheme is about 1 dB in a range of N_{SP}<=9, compared to the conventional CP-OFDM scheme. The magnitude of N_{SP} becomes smaller than QPSK or 16QAM.

Next, the throughput characteristic evaluation is described. First, the throughput for the CP-OFDM scheme and the STT-OFDM scheme is defined. The throughput for each MCS is represented by Mathematical Formula 26 (Equation (7)).

$$[ Mathematical Formula 26 ]$$

$${Λ}_{CP} = \frac{m \times {N}_{sub} \times R}{{T}_{C P}} \qquad ( 7 )$$

In Mathematical Formula 26 (Equation (7)), T_{CP}=71.4 μs is the symbol time of one CP-OFDM symbol, m is the modulation level, N_{sub} is the number of subcarriers in one OFDM symbol, and R is the coding rate.

In the STT-OFDM scheme, the throughput for each MCS and N_{SP} is represented by Mathematical Formula 27 (Equation (8)). In Mathematical Formula 27 (Equation (8)), N represents the number of sampling points in one OFDM symbol.

$$[ Mathematical Formula 27 ]$$

$${Λ}_{STT} = {A}_{CP} \times \frac{N + {N}_{CP}}{{N}_{STT}} \qquad ( 8 )$$

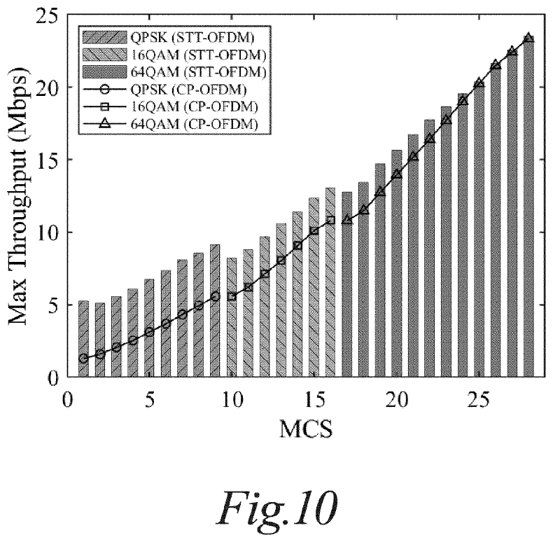

The maximum throughput achievable with the STT-OFDM scheme for each MCS is described below. To confirm the potential of the present invention, the evaluation results of the maximum throughput achievable for each MCS in the STT-OFDM scheme at high SNR (Es/No=50 dB) are shown in FIG. 10. In this evaluation, the STT-OFDM scheme applied the maximum N_{SP} that could achieve BLER=10⁻¹. The modulation scheme for MCS1-MCS9 is QPSK, the modulation scheme for MCS10-MCS16 is 16QAM, and the modulation scheme for MCS17 and above is 64QAM.

In the case of QPSK (MCS1-MCS9), the throughput is improved by up to 309% for MCS=1 and 64% for MCS=9 compared to the same MCS of the CP-OFDM scheme. In the case of QAM, the throughput can be improved by up to 47% for 16QAM (MCS10-MCS16) and up to 19% for 64QAM (MCS17-MCS28). Further, the achievable throughput is higher for MCS=9 (QPSK) than for MCS=10, 11 (16QAM), and a higher throughput than 16QAM is achieved in some cases of QPSK. Therefore, it has been shown that the STT-OFDM scheme can improve time efficiency compared to the CP-OFDM scheme using the same MCS, when sufficient desired signal power is obtained.

However, the increase in throughput for the CP-OFDM scheme decreases as the MCS increases. In the case of MCS=28, the achievable throughputs of the CP-OFDM scheme and the STT-OFDM scheme become substantially the same. Therefore, it is considered that the effectiveness of the STT-OFDM scheme is more evident in a low SNR environment, which is a target of the embodiment of the present invention.

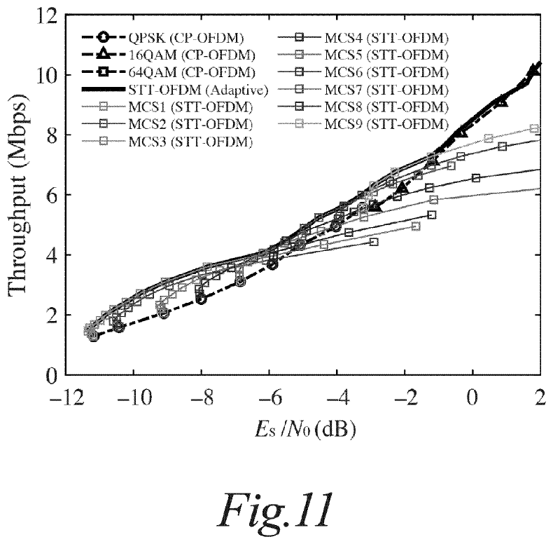

Next, throughput characteristics considering adaptive modulation is described. As an overall evaluation of the communication method of the present invention (the STT-OFDM scheme), FIGS. 11, 12 and 13 show the evaluation results of throughput characteristics when optimal MCS and N_{SP} can be adaptively selected according to the communication quality of the transmission channel. Es/No increases in order from FIG. 11 to FIG. 12 and FIG. 13. Further, in each of these figures, a graph indicated by a thick line represents the change in throughput achieved by the STT-OFDM scheme, and graphs indicated by dashed lines respectively represent changes in throughput of the CP-OFDM scheme for QPSK, 16QAM, and 64QAM.

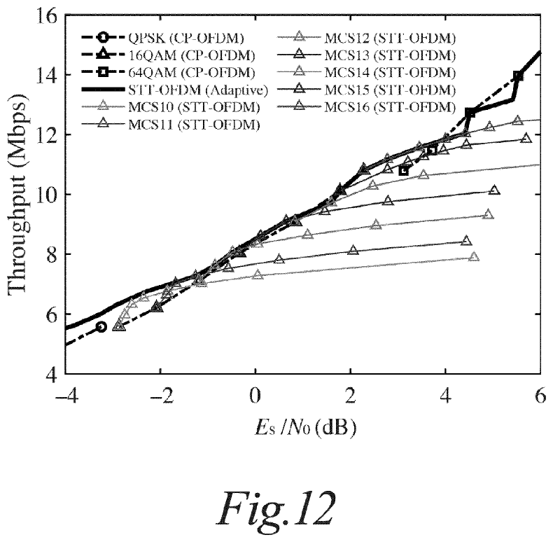

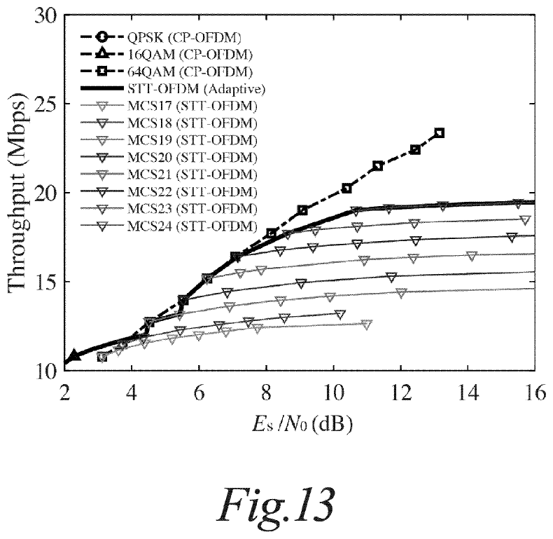

FIG. 11 shows the throughput characteristics (QPSK region) of the STT-OFDM scheme when optimal MCS and N_{SP} can be adaptively selected. FIG. 12 shows the throughput characteristics (16QAM region) of the STT-OFDM scheme when optimal MCS and N_{SP} can be adaptively selected. FIG. 13 shows the throughput characteristics (64QAM region) of the STT-OFDM scheme when optimal MCS and N_{SP} can be adaptively selected.

In the case of QPSK operating in a low SNR environment, which is the target of the present invention, as shown in FIG. 11, the STT-OFDM scheme achieved a higher throughput than the CP-OFDM scheme for all MCS values. In particular, when Es/No=−10 dB, while the throughput with the CP-OFDM scheme was 1.73 Mbps, the throughput with the STT-OFDM scheme was 2.57 Mbps, showing an improvement of about 1.5 times. Further, in the case of 16QAM, as shown in FIG. 12, when Es/No<=−1.26 dB, the STT-OFDM scheme achieved a higher throughput than the CP-OFDM scheme in some cases of MCS=10 and 11. As shown in FIG. 13, it was found that the throughput of the STT-OFDM scheme in the case of 64QAM is lower than that of the CP-OFDM scheme.

From the above, the present invention (STT-OFDM scheme) can improve throughput by about 1.5 times compared to the CP-OFDM scheme in a low SNR environment, and can contribute to expanding the coverage of next-generation systems. Further, by adaptively switching MCS according to SNR (Es/No), throughput can be satisfactorily improved.

By using the present invention, transmission energy per symbol can be reduced. For example, in low SNR regions (such as IoT communication systems covering wide areas, reception near cell edges, reception over long transmission distances, reception in cases with low transmission power in power-efficient wireless systems, communication systems implementing long-distance transmission in areas such as the sea, sky (unmanned aerial vehicles), and space), transmission efficiency can be improved by up to 1.5 times. Further, the embodiment of the present invention described above shares many common signal processing elements with transmitters and receivers of the conventional CP-OFDM scheme, offering the advantage of excellent compatibility.

In the above, the embodiments of the present invention are specifically described. However, the present invention is not limited to the above-described embodiments, and various modifications based on the technical ideas of the present invention are possible. For example, by leveraging the high compatibility feature, it is possible to adopt a structure that allows switching between the STT-OFDM scheme and the CP-OFDM scheme. Further, the functions of the structural components of the transmission device and reception device in the embodiment described above can be implemented through software processing.

### DESCRIPTION OF REFERENCE NUMERAL SYMBOLS

10: transmitter
11: channel coding circuit
12: modulation circuit
14: subcarrier mapping circuit
15: IFFT circuit
16: CP insertion circuit
17: sampling point truncation circuit
18: parallel-to-serial conversion circuit
20: receiver
21: parallel-to-serial conversion circuit
22: zero insertion circuit
23: CP removal circuit
24: FFT circuit
27: subcarrier demapping circuit
29: channel decoding circuit

1. A transmission device of an orthogonal frequency division multiplexing scheme, comprising:
a redundant signal addition circuit that adds a redundant signal of a predetermined number of sampling points to multiple sampling points of an output of an inverse discrete Fourier transform circuit; and
a sampling point truncation circuit that truncates a predetermined number of sampling points from each of a front end and a rear end of an output of the redundant signal addition circuit, wherein
an output symbol of the sampling point truncation circuit is transmitted.

2. The transmission device according to claim 1, wherein multiple symbols output from the sampling point truncation circuit are concatenated and transmitted.

3. The transmission device according to claim 2, wherein the multiple symbols are directly concatenated without providing guard intervals between the symbols.

4. The transmission device according to claim 1, wherein adaptive control is performed to select an MCS and determine a predetermined number of sampling points to be truncated according to communication quality of a transmission channel.

5. A reception device of an orthogonal frequency division multiplexing scheme, comprising:
a zero insertion circuit for inserting zero sampling points, equal in number to those truncated on a transmitting side, into a received symbol;
a redundant signal removal circuit for removing a redundant signal from an output of the zero insertion circuit; and
a discrete Fourier transform circuit for performing discrete Fourier transform on an output of the redundant signal removal circuit.

6. The reception device according to claim 5, wherein an error correction circuit is provided during an output, as a reception signal, from the discrete Fourier transform circuit.

7. A transmission method of an orthogonal frequency division multiplexing scheme, comprising:
a redundant signal addition process for adding a redundant signal of a predetermined number of sampling points to multiple sampling points of an output of an inverse discrete Fourier transform circuit;
a sampling point truncation process for truncating a predetermined number of sampling points from each of a front end and a rear end of a symbol to which the redundant signal has been added; and
transmitting the symbol from which the sampling points have been truncated.

8. A reception method of an orthogonal frequency division multiplexing scheme, comprising:
a zero insertion process for inserting zero sampling points, equal in number to those truncated on a transmitting side, into a received symbol;
a redundant signal removal process for removing a redundant signal from the symbol into which the zero sampling points have been inserted; and
a discrete Fourier transform process for performing a discrete Fourier transform on an output from which the redundant signal has been removed.

9. The transmission device of claim 2, wherein adaptive control is performed to select an MCS and determine a predetermined number of sampling points to be truncated according to communication quality of a transmission channel.
